(19) United States
(12) Patent Application Publication
(10) Pub. No.: US 2015/0341219 A1
(43) Pub. Date: Nov. 26, 2015

(54) NETWORK DEVICE AND OPERATING METHOD THEREOF

(71) Applicant: ACCTON TECHNOLOGY CORPORATION, Hsinchu (TW)

(72) Inventor: Vien-Huong HONG, HSINCHU (TW)

(21) Appl. No.: 14/474,187

(22) Filed: Sep. 1, 2014

(30) Foreign Application Priority Data
May 22, 2014 (TW) 103117921

(51) Int. Cl. H04L 12/24; G06F 9/44; H04L 12/26

(52) U.S. Cl. CPC H04L 41/0866; H04L 43/04; H04L 41/0863; H04L 43/0829; G06F 9/4401

(57) ABSTRACT

An operating method of a network device includes determining whether a first predetermined connection port and a second predetermined connection port of the network device are interconnected via a network connection element after the network device is powered on, and performing a predetermined function under a condition that the first predetermined connection port and the second predetermined connection port are interconnected via the network connection element.

This application claims priority to Taiwan Application Serial Number 103117921, filed May 22, 2014, which is herein incorporated by reference.

### BACKGROUND

1. Field of Invention

The present invention relates to an electronic device and an operating method thereof. More particularly, the present invention relates to a network device and an operating method thereof.

2. Description of Related Art

With advances in information technology, network systems are widely used in our daily lives. For example, network systems are used in the infrastructure of Internet or data centers.

A typical network system includes several network devices, such as routers and switches. The network devices are configured to receive and forward packets and frames. By using these network devices, the network system is able to function properly. Sometimes, a network device may fail and cease to be effective, making it is necessary to perform a particular function related to rectify the situation, such as performing an error recovery procedure or resetting the administrator password of the network device. However, when performing such a particular operation, special knowledge and authentication of the administrator password are needed. Authentication of the administrator password involves the hierarchy management of network security, the configurations of the network devices, and even the core configurations of the overall network system, so such authentication is not given to all the managers on each of the network hierarchy levels.

Thus, an important research relates to ways in which to allow managers to conveniently perform the particular function as described above in a short time to properly maintain a network system and increase the service quality of the network system without authentication of the administrator password.

### SUMMARY

One aspect of the present disclosure relates to an operating method applied to a network device. In accordance with one embodiment of the present disclosure, the operating method includes determining whether a first predetermined connection port and a second predetermined connection port of the network device are interconnected via a network connection element after the network device is powered on, and performing a predetermined function in case that the first predetermined connection port and the second predetermined connection port are interconnected via the network connection element.

In accordance with one embodiment of the present disclosure, the step of performing the predetermined function includes resetting an administrator password of the network device.

In accordance with one embodiment of the present disclosure, the step of performing the predetermined function includes resetting all configurations of the network device to factory default configurations.

In accordance with one embodiment of the present disclosure, the step of performing the predetermined function includes booting the network device with a backup image.

In accordance with one embodiment of the present disclosure, the step of performing the predetermined function includes booting the network device into a debug backdoor.

In accordance with one embodiment of the present disclosure, the step of determining whether the first predetermined connection port and the second predetermined connection port of the network device are interconnected via the network connection element includes outputting, through the first predetermined connection port, at least one first frame; outputting, through the second predetermined connection port, at least one second frame; determining whether the first predetermined connection port receives the second frame; determining whether the second predetermined connection port receives the first frame; and determining whether the first predetermined connection port and the second predetermined connection port are interconnected via the network connection element according to whether the first predetermined connection port receives the second frame and whether the second predetermined connection port receives the first frame.

In accordance with one embodiment of the present disclosure, the first frame and the second frame are Ethernet frames.

Another aspect of the present disclosure is related to a network device. In accordance with one embodiment of the present disclosure, the network device includes a first predetermined connection port, a second predetermined connection port, and a control component. The control component is electrically connected to the first predetermined connection port and the second predetermined connection port. The control component is configured for determining whether the first predetermined connection port and the second predetermined connection port of the network device are interconnected via a network connection element after the network device is powered on, and performing a predetermined function under a condition that the first predetermined connection port and the second predetermined connection port are interconnected via the network connection element.

In accordance with one embodiment of the present disclosure, the predetermined function of the network device includes resetting an administrator password of the network device.

In accordance with one embodiment of the present disclosure, the predetermined function of the network device includes resetting all configurations of the network device to factory default configurations.

In accordance with one embodiment of the present disclosure, the predetermined function of the network device includes booting the network device with a backup image.

In accordance with one embodiment of the present disclosure, the predetermined function of the network device includes booting the network device into a debug backdoor.

In accordance with one embodiment of the present disclosure, the control component is further configured for outputting, through the first predetermined connection port, at least one first frame; outputting, through the second predetermined connection port, at least one second frame; determining whether the first predetermined connection port receives the second frame; determining whether the second predetermined connection port receives the first frame; and determining whether the first predetermined connection port and the second predetermined connection port are interconnected via the network connection element according to whether the first predetermined connection port receives the second frame and whether the second predetermined connection port receives the first frame.

In accordance with one embodiment of the present disclosure, the first frame and the second frame are Ethernet frames.

Another aspect of the present disclosure is related to a network device. In accordance with one embodiment of the present disclosure, the network device includes a first connection port group, a second connection port group, and a control component. The first connection port group includes a plurality of first predetermined connection ports. The second connection port group includes a plurality of second predetermined connection ports. The control component is electrically connected to the first and second predetermined connection ports. The control component is configured for determining whether any one of the first predetermined connection ports of the first connection port group and any one of the second predetermined connection ports of the second connection port group are interconnected via a network connection element after the network device is powered on, and performing a predetermined function in case that one of the first predetermined connection ports and one of the second predetermined connection ports are interconnected via the network connection element.

In accordance with one embodiment of the present disclosure, the control component is further configured for outputting, through the first predetermined connection ports of the first connection port group, a plurality of first frames destined to each of the second predetermined connection ports of the second connection port group; outputting, through the second predetermined connection ports, a plurality of second frames destined to each of the first predetermined connection ports; determining whether a first connection port from among the first predetermined connection ports receives a corresponding second frame of the second frames which is outputted from a second connection port from among the second predetermined connection ports; determining whether the second connection port receives a corresponding first frame of the first frames which is outputted from the first connection port; and determining whether the first connection port and the second connection port are interconnected via the network connection element according to whether the first connection port receives the corresponding second frame which is outputted from the second connection port and whether the second connection port receives the corresponding first frame which is outputted from the first connection port.

Through utilizing one embodiment described above, the network device can perform the predetermined function under the condition that the first predetermined connection port and the second predetermined connection port are interconnected. As a result, it is convenient for a manager to control the network device to perform the predetermined function (e.g., perform an error recovery procedure or reset the administrator password of the network device) in a short time. Hence, the network system can be easily maintained, and the service quality of the network system can be increased.

### BRIEF DESCRIPTION OF THE DRAWINGS

FIG. 1 is a schematic diagram of a network device according to one embodiment of the present invention.

FIG. 2 is a flowchart of an operating method of a network device according to one embodiment of the present invention.

FIG. 3 illustrates a first/second frame according to one embodiment of the present invention.

FIG. 4 is a flowchart of an operating method according to another embodiment of the present invention.

FIG. 5 is a flowchart of an operating method according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Also, “electrically connect” or “connect” can further refer to the interoperation or interaction between two or more elements.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. §112(f). In particular, the use of “step of” in the claims herein is not intended to invoke the provisions of 35 U.S.C. §112(f).

One aspect of the present disclosure is related to a network device. To facilitate the description, a switch is taken as a descriptive example in the following paragraphs. However, the present disclosure is not limited to the embodiment below.

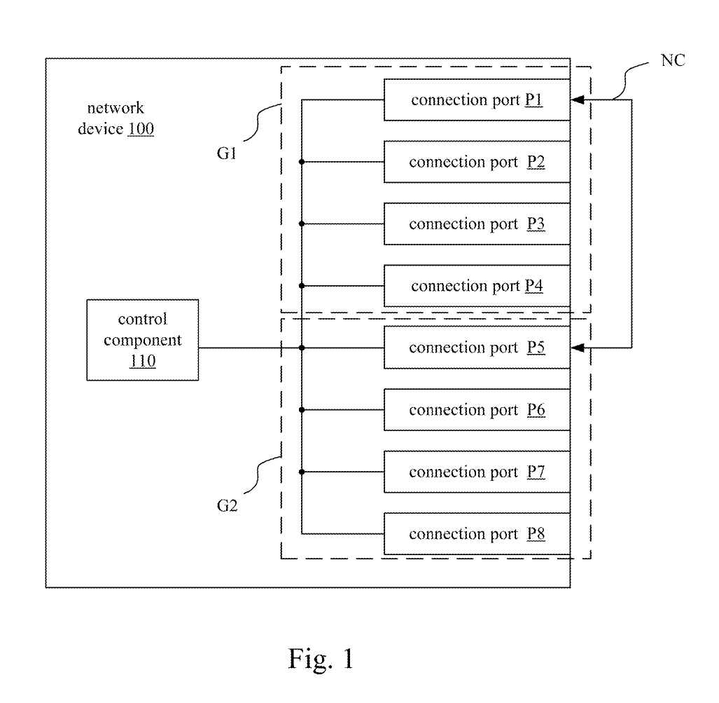

FIG. 1 is a schematic diagram of a network device 100 according to one embodiment of the present invention.

The network device 100 includes a control component 110 and a plurality of connection ports P1-P8. In this embodiment, the control component 110 is electrically connected to the connection ports P1-P8.

It should be noted that the number of the connection ports P1-P8 described above is for illustrative purposes, and the present disclosure is not limited in this regard. In addition, the connections among the components in the network device 100 are not limited by the embodiment above, and any connection and configuration enabling the network device 100 to practice the technical features described below can be used herein.

In this embodiment, the network device 100 can perform some commonly used operations (e.g., forwarding frames) through the control component 110. In addition, in some circumstances, the network device 100 can utilize the control component 110 to perform a particular function, such as performing an error recovery procedure or resetting the administrator password of the network device 100. In one embodiment, the functions of the control component 110 can be realized by a processor implementing a computer program stored in a computer readable storage medium. The processor can be realized by, for example, a central processing unit (CPU), a digital signal processor (DSP), a micro processor, or another suitable computing component. The computer readable storage medium can be realized by, for example, a ROM (read-only memory), a flash memory, a floppy disc, a hard disc, a flash disc, or another suitable storage component.

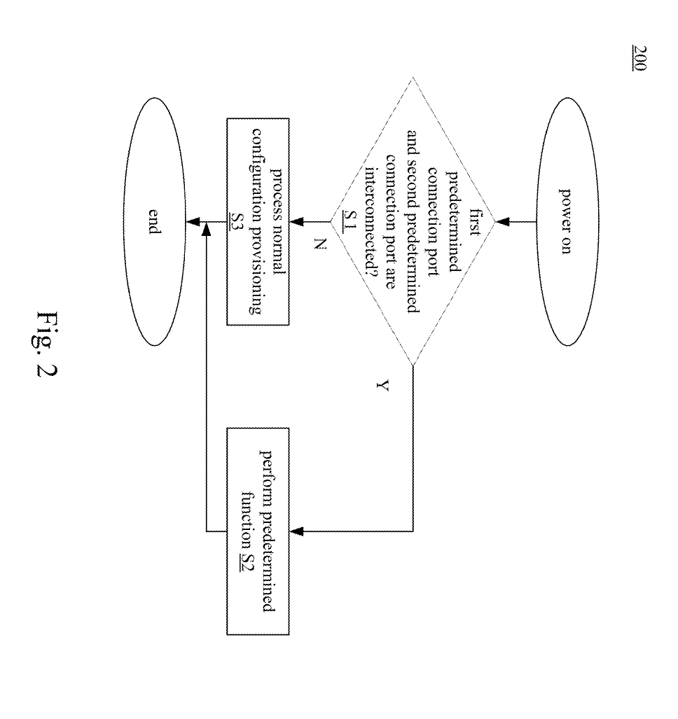

In the following description, details of the present disclosure are provided with reference to an operating method of a network device in FIG. 2, but the present disclosure is not limited by the embodiment below.

It should be noted that the operating method can be applied to a network device having a structure that is the same as or similar to the structure shown in FIG. 1. To simplify the description in the following paragraphs, the embodiment shown in FIG. 1 will be used as an example to describe the operating method according to an embodiment of the present disclosure. However, the present disclosure is not limited to application to the embodiment shown in FIG. 1.

In addition, it should be noted that, in the steps of the following operating method, no particular sequence is required unless otherwise specified. Moreover, the following steps also may be performed simultaneously or the execution times thereof may at least partially overlap.

Furthermore, the steps of the following operating method may be added, replaced, and/or eliminated as appropriate, in accordance with various embodiments of the present disclosure.

FIG. 2 is a flowchart of an operating method of a network device according to one embodiment of the present invention.

In step S1, during a predetermined period after the network device 100 is powered on (or reloaded), the network device 100 determines whether a first predetermined connection port (e.g., the connection port P1) and a second predetermined connection port (e.g., the connection port P5) from among the connection ports P1-P8 are interconnected via a network connection element NC (e.g., a network cable) through the control component 110. If so, step S2 is performed; if not, step S3 is performed.

It is noted that the first and second predetermined connection ports can be changed by the manager to other connection ports from among the connection ports P1-P8 on the basis of actual requirements, and the present disclosure is not limited by the embodiment above.

In step S2, under a condition that the first predetermined connection port and the second predetermined connection port from among the connection ports P1-P8 are interconnected via a network connection element NC, the network device 100 performs a predetermined function through the control component 110.

In one embodiment, the predetermined function includes at least one of resetting an administrator password of the network device 100 (e.g., resetting the administrator password to a default value), resetting all configurations of the network device 100 to factory default configurations, booting the network device 100 with a backup image, and booting the network device into a debug backdoor.

In step S3, under a condition that the first predetermined connection port and the second predetermined connection port from among the connection ports P1-P8 are not interconnected via a network connection element NC, the network device 100 performs normal configuration provisioning by the control component 110.

Through the configuration and operations mentioned above, the network device 100 can perform the predetermined function in case that the first predetermined connection port and the second predetermined connection port are interconnected. As a result, it is convenient for a manager to control the network device 100 to perform the predetermined function (e.g., perform an error recovery procedure or reset the administrator password of the network device 100) in a short time. Hence, the network system configured with the network device 100 can be easily maintained, and the service quality of the network system can be increased.

In one embodiment of the present disclosure, step S1 may include sub-steps as described below.

In a first step, during the predetermined period after the network device 100 is powered on (or reloaded), the control component 110 outputs a first frame EF1 and a second frame EF2 respectively through the first predetermined connection port and the second predetermined connection port. In one embodiment, both of the first frame EF1 and second frame EF2 may be successively outputted a plurality of times (e.g., 3 times).

Subsequently, the control component 110 determines whether the first predetermined connection port receives the second frame EF2 from the second predetermined connection port, and whether the second predetermined connection port receives the first frame EF1 from the first predetermined connection port.

Next, the control component 110 determines whether the first predetermined connection port and the second predetermined connection port are interconnected via a network connection element NC according to whether the first predetermined connection port receives the second frame EF2 from the second predetermined connection port and whether the second predetermined connection port receives the first frame EF1 from the first predetermined connection port. For example, when the first predetermined connection port receives the second frame EF2 from the second predetermined connection port and the second predetermined connection port receives the first frame EF1 from the first predetermined connection port, the control component 110 determines that the first predetermined connection port and the second predetermined connection port are interconnected via a network connection element NC.

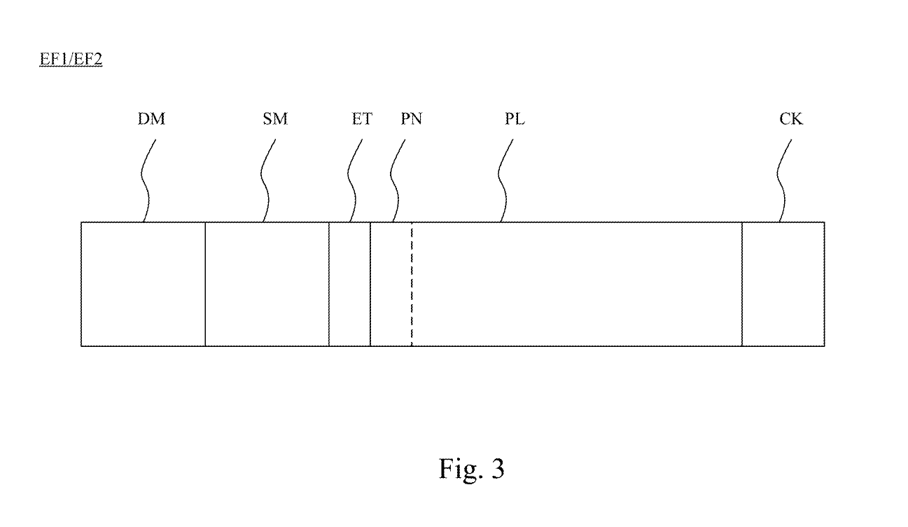

FIG. 3 illustrates a frame structure of the first/second frame EF1/EF2 according to one embodiment of the present invention. In this embodiment, both of the first frame EF1 and the second frame EF2 may be Ethernet frames. In this embodiment, the first/second frame EF1/EF2 may include a destination media access control (MAC) address field DM (with a length of 6 bytes), a source MAC address field SM (with a length of 6 bytes), an Ethertype field ET (with a length of 2 bytes), a payload field PL (with a length of 46 bytes), and a frame check sequence (FCS) field CK (with a length of 4 bytes). In one embodiment, the payload field PL further includes a physical source connection port number field PN.

For example, in one embodiment, the source MAC address field SM of the first frame EF1 may record the MAC address of the first predetermined connection port. The destination MAC address field DM of the first frame EF1 may record the MAC address of the second predetermined connection port. The physical source connection port number field PN of the first frame EF1 may record the physical port number of the first predetermined connection port. The source MAC address field SM of the second frame EF2 may record the MAC address of the second predetermined connection port. The destination MAC address field DM of the second frame EF2 may record the MAC address of the first predetermined connection port. The physical source connection port number field PN of the second frame EF2 may record the physical port number of the second predetermined connection port.

In one embodiment, the MAC addresses of the first and second predetermined connection ports are equal to the summations of the MAC address of the network device 100 and the physical port numbers of the first and second predetermined connection ports respectively. For example, under a condition that the MAC address of the network device 100 is 00-12-CF-00-00-A0, the MAC address of the first predetermined connection port (e.g., the connection port P1) is 00-12-CF-00-00-A1, and the MAC address of the second predetermined connection port (e.g., the connection port P5) is 00-12-CF-00-00-A5.

In one embodiment, when the network device 100 only supports one MAC address for the whole network system, the destination MAC address fields DM of the first/second frames EF1/EF2 may record broadcast addresses (e.g., FF-FF-FF-FF-FF-FF), and the source MAC address fields SM of the first/second frames EF1/EF2 may record the MAC address of the network device 100.

Through the configuration and operations mentioned above, the network device 100 can determine whether the first predetermined connection port receives the second frame EF2 from the second predetermined connection port and whether the second predetermined connection port receives the first frame EF1 from the first predetermined connection port.

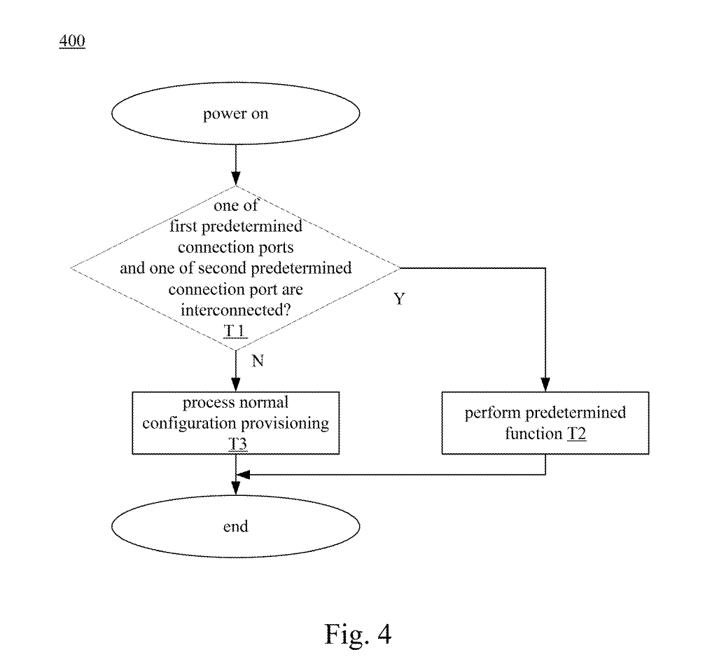

FIG. 4 is a flowchart of an operating method 400 of a network device according to another embodiment of the present invention.

It should be noted that the operating method 400 can be applied to a network device having a structure that is the same as or similar to the structure shown in FIG. 1. To simplify the description in the following paragraphs, the embodiment shown in FIG. 1 will be used as an example to describe the operating method 400 according to an embodiment of the present disclosure. However, the current disclosure is not limited to the embodiment shown in FIG. 1.

In this embodiment, the operating method 400 includes the steps below.

In step T1, during a predetermined period after the network device 100 is powered on (or reloaded), the network device 100 determines whether any one of the first predetermined connection ports (e.g., the connection ports P1-P4) of a first connection port group G1 and any one of the second predetermined connection ports (e.g., the connection ports P5-P8) of a second connection port group G2 are interconnected via a network connection element NC (e.g., a network cable). If so, step T2 is performed; if not, step T3 is performed.

It should be noted that the connection ports belonging to the first and second connection port groups G1, G2 can be varied on the basis of actual requirements, and the present disclosure is not limited by the embodiment shown in FIG. 1.

In step S2, under a condition that one of the first predetermined connection ports of the first connection port group G1 and one of the second predetermined connection ports of the second connection port group G2 are interconnected via the network connection element NC, the network device 100 performs a predetermined function through the control component 110.

It should be noted that details of the predetermined function can be referred to the above paragraphs, and a description will not be repeated herein.

In step T3, under a condition that none of the first predetermined connection ports of the first connection port group G1 and the second predetermined connection ports of the second connection port group G2 are interconnected via a network connection element NC, the network device 100 performs normal configuration provisioning through the control component 110.

Through the configuration and operations mentioned above, the network device 100 can perform the predetermined function under the condition that one of the first predetermined connection ports of the first connection port group G1 and one of the second predetermined connection ports of the second connection port group G2 are interconnected. As a result, it is convenient for a manager to control the network device 100 to perform the predetermined function (e.g., perform an error recovery procedure or reset the administrator password of the network device 100) in a short time. Hence, the network system constructed with the network device 100 can be easily maintained, and the service quality of the network system can be increased.

In one embodiment of the present disclosure, step T1 may include the sub-steps below.

In a first step, during a predetermined period after the network device 100 is powered on (or reloaded), the control component 110 outputs first frames EF1 separately destined to each of the second predetermined connection ports of the second connection port group G2 through each of the first predetermined connection ports of the first connection port group G1, and outputs second frames EF2 separately destined to each of the first predetermined connection ports of the first connection port group G1 through each of the second predetermined connection ports of the second connection port group G2.

For example, under a condition that the first connection port group G1 includes the connection ports P1-P4 and the second connection port group G2 includes the connection ports P5-P8, each of the connection ports P1-P4 outputs the first frames EF1 destined to each of the connection ports P5-P8. Similarly, each of the connection ports P5-P8 outputs the second frames EF2 destined to each of the connection ports P1-P4. It should be noted that the contents of the destination MAC address fields DM, the source MAC address fields SM, and the physical source connection port number fields PN of the first and second frames EF1, EF2 may be varied in a manner corresponding to the sources and destinations of the first and second frames EF1, EF2. The details of the contents of the first and second frames EF1, EF2 can be referred to the above paragraphs, and a description will not be repeated herein.

Subsequently, the control component 110 determines whether one of the first predetermined connection ports of the first connection port group G1 (e.g., a first connection port) receives the second frame EF2 from one of the second predetermined connection ports of the second connection port group G2 (e.g., a second connection port), and determines whether the one of the second predetermined connection ports (e.g., the second connection port) receives the first frame EF1 from the one of the first predetermined connection ports (e.g., the first connection port).

Next, the control component 110 determines whether one of the first predetermined connection ports of the first connection port group G1 and one of the second predetermined connection ports of the second connection port group G2 are interconnected via a network connection element NC according to whether one of the first predetermined connection ports (e.g., the first connection port) receives the second frame EF2 from one of the second predetermined connection ports (e.g., the second connection port), and determines whether the one of the second predetermined connection ports (e.g., the second connection port) receives the first frame EF1 from the one of the first predetermined connection ports (e.g., the first connection port). For example, when the connection port P1 of the first connection port group G1 receives the second frame EF2 from the connection port P5 of the second connection port group G2, and the connection port P5 receives the first frame EF1 from the connection port P1, the control component 110 determines that the connection port P1 of the first connection port group G1 and the connection port P5 of the first connection port group G2 are interconnected via a network connection element NC.

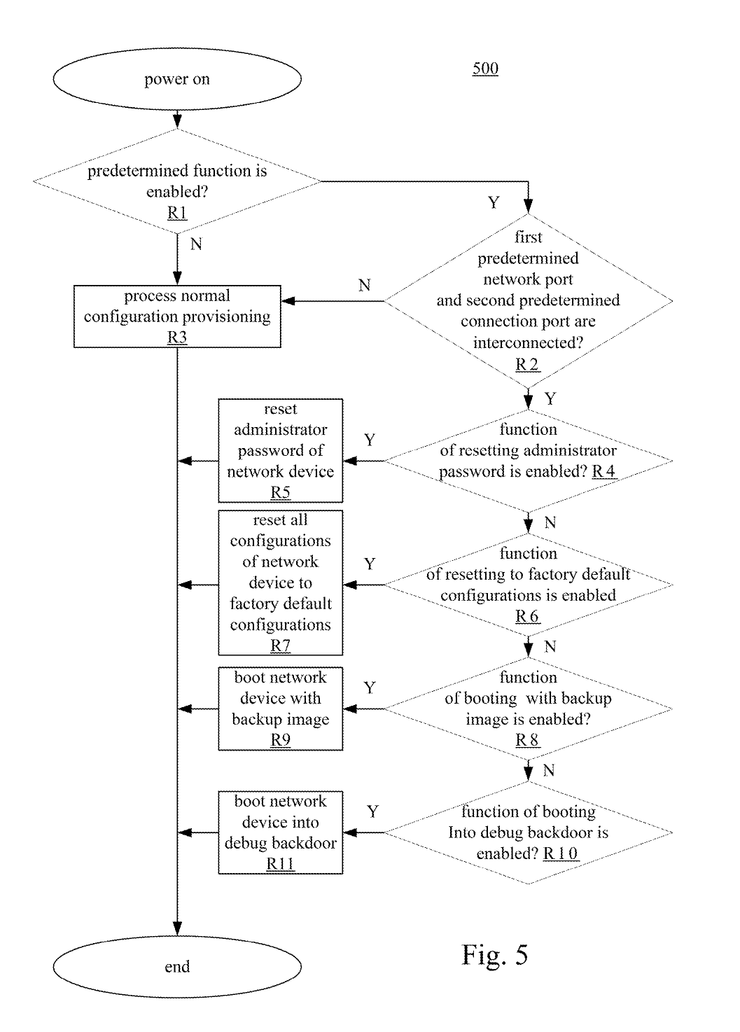

FIG. 5 is a flowchart of an operating method 500 of a network device according to another embodiment of the present invention.

It should be noted that the operating method 500 can be applied to a network device having a structure that is the same as or similar to the structure shown in FIG. 1. To simplify the description in the following paragraphs, the embodiment shown in FIG. 1 will be used as an example to describe the operating method 500 according to an embodiment of the present disclosure. However, the present disclosure is not limited to the embodiment shown in FIG. 1.

In this embodiment, the operating method 500 includes the steps below.

In step R1, after the network device 100 is powered on (or reloaded), the network device 100 determines whether the predetermined function (e.g., at least one of resetting an administrator password of the network device 100, resetting all configurations of the network device 100 to factory default configurations, booting the network device 100 with a backup image, and booting the network device into a debug backdoor) is enabled through the control component 110. If so, step R2 is performed; if not, step R3 is performed.

It should be noted that, in different operating conditions, the manager can enable a different predetermined function (e.g., enable at least one of resetting an administrator password of the network device 100, resetting all configurations of the network device 100 to factory default configurations, booting the network device 100 with a backup image, and booting the network device 100 into a debug backdoor) optionally on the basis of actual requirements.

In step R2, under a condition that the predetermined function is enabled, the network device can determine whether a first predetermined connection port and a second predetermined connection port from among the connection ports P1-P8 are interconnected via a network connection element NC by the control component 110. If so, step R4 is performed; if not, step R3 is performed.

It should be noted that details in connection with step R2 can be ascertained by referring to the paragraphs corresponding to step S1, and a description in this regard will not be repeated herein.

In step R3, under a condition that the first predetermined connection port and the second predetermined connection port from among the connection ports P1-P8 are not interconnected via a network connection element NC, the network device 100 performs normal configuration provisioning through the control component 110.

In step R4, under a condition that the first predetermined connection port and the second predetermined connection port from among the connection ports P1-P8 are interconnected via a network connection element NC, the network device 100 determines whether a function of resetting an administrator password of the network device 100 is enabled through the control component 110. If so, step R5 is performed; if not, step R6 is performed.

In step R5, under a condition that the function of resetting the administrator password of the network device 100 is enabled, the network device 100 resets the administrator password of the network device 100 through the control component 110.

In step R6, under a condition that the function of resetting the administrator password of the network device 100 is disabled, the network device 100 determines whether a function of resetting all configurations of the network device 100 to factory default configurations is enabled through the control component 110. If so, step R7 is performed; if not, step R8 is performed.

In step R7, in case that the function of resetting all of the configurations of the network device 100 to the factory default configurations is enabled, the network device 100 resets all of the configurations of the network device 100 to the factory default configurations through the control component 110.

In step R8, under a condition that the function of resetting all of the configurations of the network device 100 to the factory default configurations is disabled, the network device 100 determines whether a function of booting the network device 100 with a backup image is enabled through the control component 110. If so, step R9 is performed; if not, step R10 is performed.

In step R9, under a condition that the function of booting the network device 100 with a backup image is enabled, the network device 100 boots itself with the backup image through the control component 110.

In step R10, in case that the function of booting the network device 100 with the backup image is disabled, the network device 100 determines whether a function of booting the network device 100 into a debug backdoor is enabled through the control component 110. If so, step R11 is performed.

In step R11, under a condition that the function of booting the network device 100 into the debug backdoor is enabled, the network device 100 boots itself into the debug backdoor.

Through the configurations and operations mentioned above, the network device 100 can perform the predetermined function under the condition that the first predetermined connection port and the second predetermined connection port are interconnected. As a result, it is convenient for a manager to control the network device 100 to perform the predetermined function (e.g., reset the administrator password of the network device 100, reset all of the configurations of the network device 100 to the factory default configurations, boot the network device 100 with the backup image, and boot the network device 100 into the debug backdoor) in a short time. Hence, the network system constructed with the network device 100 can be easily maintained, and the service quality of the network system can be increased.

Moreover, in some different embodiments, in the operating method 500, the predetermined function can be performed under the circumstance that one connection port of the first connection port group G1 and one connection port of the second connection port group G2 are interconnected. Details of such a configuration can be ascertained by referring to previous paragraphs, and a description in this regard will not be repeated herein.

Although the present invention has been described in considerable detail with reference to certain embodiments thereof, other embodiments are possible. Therefore, the scope of the appended claims should not be limited to the description of the embodiments contained herein.

What is claimed is:

1. An operating method applied to a network device, the operating method comprising:
determining whether a first predetermined connection port and a second predetermined connection port of the network device are interconnected via a network connection element after the network device is powered on; and
performing a predetermined function under a condition that the first predetermined connection port and the second predetermined connection port are interconnected via the network connection element.

2. The operating method as claimed in claim 1, wherein the step of performing the predetermined function comprises resetting an administrator password of the network device.

3. The operating method as claimed in claim 1, wherein the step of performing the predetermined function comprises resetting all configurations of the network device to factory default configurations.

4. The operating method as claimed in claim 1, wherein the step of performing the predetermined function comprises booting the network device with a backup image.

5. The operating method as claimed in claim 1, wherein the step of performing the predetermined function comprises booting the network device into a debug backdoor.

6. The operating method as claimed in claim 1, wherein the step of determining whether the first predetermined connection port and the second predetermined connection port of the network device are interconnected via the network connection element comprises:
outputting, through the first predetermined connection port, at least one first frame;
outputting, through the second predetermined connection port, at least one second frame;
determining whether the first predetermined connection port receives the second frame;
determining whether the second predetermined connection port receives the first frame; and
determining whether the first predetermined connection port and the second predetermined connection port are interconnected via the network connection element according to whether the first predetermined connection port receives the second frame and whether the second predetermined connection port receives the first frame.

7. The operating method as claimed in claim 6, wherein the first frame and the second frame are Ethernet frames.

8. A network device comprising:
a first predetermined connection port;
a second predetermined connection port; and
a control component electrically connected to the first predetermined connection port and the second predetermined connection port, wherein the control component is configured for:
determining whether the first predetermined connection port and the second predetermined connection port of the network device are interconnected via a network connection element after the network device is powered on; and
performing a predetermined function under a condition that the first predetermined connection port and the second predetermined connection port are interconnected via the network connection element.

9. The network device as claimed in claim 8, wherein the predetermined function comprises resetting an administrator password of the network device.

10. The network device as claimed in claim 8, wherein the predetermined function comprises resetting all configurations of the network device to factory default configurations.

11. The network device as claimed in claim 8, wherein the predetermined function comprises booting the network device with a backup image.

12. The network device as claimed in claim 8, wherein the predetermined function comprises booting the network device into a debug backdoor.

13. The network device as claimed in claim 8, wherein the control component is further configured for:
outputting, through the first predetermined connection port, at least one first frame;
outputting, through the second predetermined connection port, at least one second frame;
determining whether the first predetermined connection port receives the second frame;
determining whether the second predetermined connection port receives the first frame; and
determining whether the first predetermined connection port and the second predetermined connection port are interconnected via the network connection element according to whether the first predetermined connection port receives the second frame and whether the second predetermined connection port receives the first frame.

14. The network device as claimed in claim 13, wherein the first frame and the second frame are Ethernet frames.

15. A network device comprising:
a first connection port group comprising a plurality of first predetermined connection ports;
a second connection port group comprising a plurality of second predetermined connection ports; and
a control component electrically connected to the first and second predetermined connection ports, wherein the control component is configured for:
determining whether any one of the first predetermined connection ports of the first connection port group and any one of the second predetermined connection ports of the second connection port group are interconnected via a network connection element after the network device is powered on; and
performing a predetermined function under a condition that one of the first predetermined connection ports of the first connection port group and one of the second predetermined connection ports of the second connection port group are interconnected via the network connection element.

16. The network device as claimed in claim 15, wherein the control component is further configured for:
outputting, through the first predetermined connection ports of the first connection port group, a plurality of first frames destined to each of the second predetermined connection ports of the second connection port group;
outputting, through the second predetermined connection ports of the second connection port group, a plurality of second frames destined to each of the first predetermined connection ports of the first connection port group;
determining whether a first connection port from among the first predetermined connection ports of the first connection port group receives a corresponding second frame of the second frames which is outputted from a second connection port from among the second predetermined connection ports of the second connection port group;
determining whether the second connection port receives a corresponding first frame of the first frames which is outputted from the first connection port; and
determining whether the first connection port and the second connection port are interconnected via the network connection element according to whether the first connection port receives the corresponding second frame which is outputted from the second connection port and whether the second connection port receives the corresponding first frame which is outputted from the first connection port.

17. The network device as claimed in claim 16, wherein the predetermined function comprises resetting an administrator password of the network device.

18. The network device as claimed in claim 16, wherein the predetermined function comprises resetting all configurations of the network device to factory default configurations.

19. The network device as claimed in claim 16, wherein the predetermined function comprises booting the network device with a backup image.

20. The network device as claimed in claim 8, wherein the predetermined function comprises booting the network device into a debug backdoor.
